(19) United States
(12) Patent Application Publication
(10) Pub. No.: US 2005/0028172 A1
(43) Pub. Date: Feb. 3, 2005

(54) Method and apparatus for installing software

(75) Inventors: Hiroto Yoshikawa, Kyoto (JP); Natsuko Kagawa, San Jose, CA (US); Kihoon Park, Cupertino, CA (US); Tatsuya Takahashi, Santa Clara, CA (US)

Correspondence Address: McDERMOTT, WILL & EMERY, 600 13th Street, N.W., Washington, DC, 20005-3096, US

(73) Assignee: MATSUSHITA ELECTRIC INDUSTRIAL CO., LTD.

(21) Appl. No.: 10/629,842

(22) Filed: Jul. 30, 2003

(51) Int. Cl. G06F 9/46; G06F 13/12; G06F 3/00

(52) U.S. Cl. 719/321; 710/62; 710/8

(57) ABSTRACT

A method of installing a software program in a host device, which is required for the host device to communicate with a peripheral device. The method includes the steps of coupling the host device to the peripheral device, which contains the software program stored in a memory device contained in the peripheral device, utilizing a USB serial interface; uploading the software program from the peripheral device to the host device; and installing the software program in the host device thereby allowing communication between the host device and the peripheral device.

### FIELD OF THE INVENTION

The present invention relates to a method and apparatus for installing software in a host device, and more particularly, to a method and apparatus for uploading drivers and applications to a host device from a peripheral device which are interfaced with one another utilizing a Universal Serial Bus (USB).

### BACKGROUND OF THE INVENTION

The use of the Universal Serial Bus (USB) protocol for transferring data between a host device (i.e., master device) and a peripheral device (i.e., slave device) is well known. For example, the USB protocol is explained in detail in “Universal Serial Bus System Architecture”, Second Edition, Mindshare, Inc., which is hereby incorporated by reference.

FIG. 1 is a block diagram illustrating a functional overview of a typical prior art system for transferring data between a host device and a peripheral device utilizing the USB interface. As shown, the host device 10 includes an application software layer 12 (i.e., operating system software and application software run by the host device), and a USB system software layer 14, which includes a USB bus driver and a USB host controller driver. Typically, the USB bus driver knows the characteristics of the USB peripheral device, and provides the necessary information for communicating with the peripheral device. The USB host controller driver functions to schedule transactions to be transmitted over the USB bus. The host device 10 further includes a USB host controller/interface layer 16 which functions to generate the transactions authorized by the USB host controller driver and to transmit the instructions/data over the bus.

Generally speaking, the peripheral device 20 includes a USB bus interface layer 22, a USB device layer 24 and a functional layer 26. The USB bus interface layer 22 functions to control the receipt and transmission of data between the host device and the peripheral device in accordance with the USB protocol. The USB device layer 24 functions to comprehend the USB communication requirements necessary to transfer data between the given peripheral device and the host device. The functional layer 26 represents the function to be performed by the given peripheral device.

Traditionally, the implementation of USB protocols have been very “PC centric”, in that a personal computer (PC) functioned as the host device when coupling numerous USB compatible devices to one another. As a result, when transferring data between, for example, a digital camera and a printer, it was required to couple both the digital camera and the printer to the host PC so as to allow the PC to function as the host device and manage the transfer of data between the two peripheral devices. In such a setup, the software drivers necessary for the PC to access and communicate with the various peripheral devices were stored in the memory of the PC, as typically, the PC would have an abundance of available memory.

In an effort to eliminate the need for the use of the PC, a new specification referred to as “USB-On-The-GO” has been developed. In accordance with the new USB specification, it is possible for two devices (e.g., the digital camera and the printer) to be coupled to one another directly, without the use of the PC.

While “USB-On-The-Go” specification has been successful in eliminating the need for the use of a PC to transfer data between peripherals, various shortcomings remain. For example, in accordance with the “USB-On-The-Go” specification it is still necessary for one of the peripheral devices to function as the master or host device and the other as the slave or peripheral device. As a result, it is necessary for the host device to contain the software drivers and applications necessary to access and communicate with the peripheral device coupled thereto. For example, utilizing the example noted above, if the digital camera is to act as the host device to a printer coupled thereto, the digital camera must contain the required software drivers and applications that allow the digital camera to communicate with the printer. Thus, it is required that the digital camera contain the drivers and applications of every printer that it is intended to communicate with at the time the device is manufactured (i.e., prior to the sale of the camera). However, as the memory space available for storing drivers and applications in devices such as a digital camera is significantly limited, as a practical matter the number of devices that a digital camera can be coupled to is undesirable quite minimal.

As a result, currently, product manufacturers must decide which devices a given product may be coupled to, and then provide the drivers and applications associated with those devices in the memory of the given product during the manufacturing process. The consumer of the given product is then informed what devices the product is compatible with at the time of purchase. If the consumer attempts to utilize the product with other devices, for which the product does not contain drivers, the consumer would be unable to do so. Furthermore, in many such products, such as the digital camera, there are no means for the consumer to download additional drivers into the products even if the consumer was inclined to do so.

Accordingly, there exists a need to solve the foregoing problem, and more specifically, to allow a device functioning in accordance with the USB-On-The-GO specification to obtain the software drivers and applications necessary to communicate with various devices subsequent to the manufacture and sale of the device so as to allow the consumer to utilize the device with essentially any other suitable peripheral device.

### SUMMARY OF THE INVENTION

In an effort to solve the aforementioned needs, it is an object of the present invention to provide a method an apparatus for allowing a host device to obtain the necessary software drivers and applications from the peripheral device to which it is coupled, so as to eliminate the need for the host device to contain drivers and applications specific to a given peripheral device prior to the host device being coupled to the peripheral device.

More specifically, the present invention relates to a method of installing a software program in a host device, which is required for the host device to communicate with a peripheral device. The method includes the steps of coupling the host device to the peripheral device, which contains the software program stored in a memory device contained in the peripheral device, utilizing a USB serial interface; uploading the software program from the peripheral device to the host device; and installing the software program in the host device thereby allowing communication between the host device and the peripheral device.

The present invention also relates to a host device capable of communicating with any one of a plurality of peripheral devices utilizing a USB serial interface, where each of the plurality of peripheral devices has the software drivers necessary for communicating with the given peripheral device stored in a memory device contained in the given peripheral. The host device comprises a USB interface capable of defining/identifying the host device as a master device relative to the plurality of peripheral devices, a software driver uploader for uploading the software driver of a given one of the plurality of peripheral devices, which is currently coupled to the host device via the USB serial interface, and a software driver installer for installing the software driver uploaded from the given one of the plurality of peripheral devices so as to allow communication between the host device and the given one of said plurality of peripheral devices.

As described in further detail below, the present invention provides significant advantages over the prior art. Most importantly, the present invention effectively unconditionally expands the number of peripheral devices that a given host device can be connected to. In other words, manufacturers are no longer limited to specifying a set number of peripheral devices that a given host can be coupled to (which in the prior art is limited by the number of drivers that can be stored in the host device at the time of manufacture). In accordance with the present invention, if the host device does not contain the necessary driver and application to interact with a peripheral device, the driver and application are simply uploaded from the peripheral device.

Another advantage is that the present invention reduces the amount of memory required for the host device. More specifically, as the host device is no longer required to store all of the drivers and applications for which the manufacturer wishes the host to be compatible with, the memory requirements of the host device are significantly reduced.

Another advantage is that drivers and applications are easily upgradeable, for example, to add a new feature or correct a newly discovered bug or error.

Additional advantages of the present invention will become apparent to those skilled in the art from the following detailed description of exemplary embodiments of the present invention.

The invention itself, together with further objects and advantages, can be better understood by reference to the following detailed description and the accompanying drawings.

### BRIEF DESCRIPTION OF THE DRAWINGS

FIG. 1 is a block diagram illustrating a functional overview of a typical prior art system for transferring data between a host device and a peripheral device utilizing the USB interface.

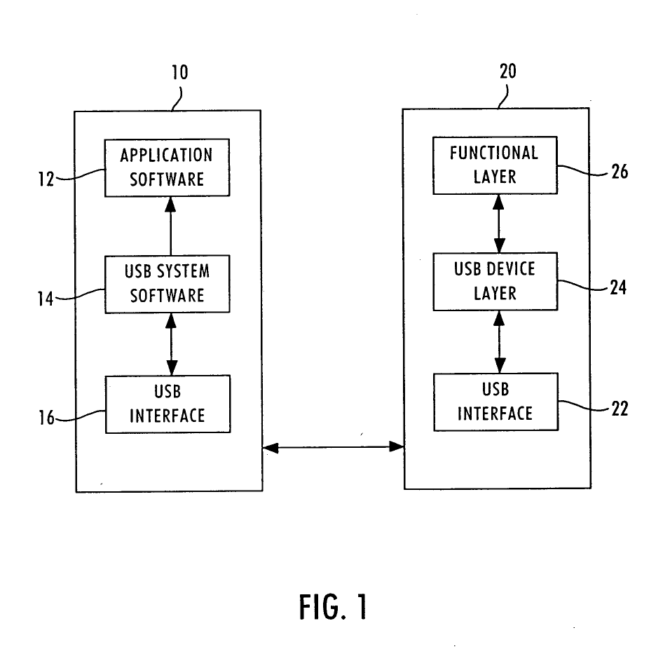

FIG. 2 is a block diagram illustrating in-part the contents of a host device practicing the prior art and a peripheral device coupled thereto.

FIG. 3 is a block diagram illustrating in-part the contents of an exemplary host device practicing the present invention and a peripheral device coupled thereto.

FIG. 4A is a flowchart illustrating the execution of an exemplary USB application uploader program in accordance with the present invention.

FIG. 4B is a flowchart illustrating the execution of an exemplary USB driver uploader program in accordance with the present invention, showing exemplary steps for uploading the driver.

FIG. 5 is a flowchart illustrating the execution of an exemplary USB application uploader program in accordance with the present invention, showing exemplary steps for uploading the application.

### DETAILED DESCRIPTION OF THE INVENTION

The following detailed description relates to a novel method for installing drivers and applications in a host device operating in accordance with the “USB-On-The-GO” specification. In the description, numerous specific details are set forth regarding the novel method. It will be obvious, however, to one skilled in the art that these specific details need not be employed to practice the present invention, and that the method of the present invention is not limited to “USB-On-The-GO” compliant devices. Moreover, well-known aspects of the USB interface and requirements have not been described in detail in order to avoid unnecessarily obscuring the present invention.

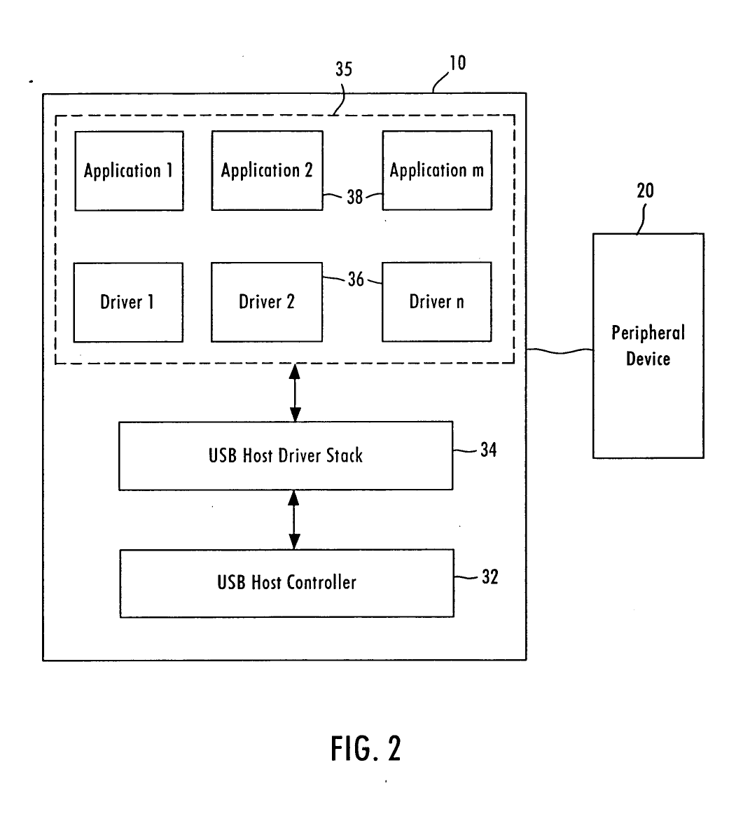

FIG. 2 is a block diagram illustrating in-part the contents of a host device 10 practicing the prior art and a peripheral device 20 coupled thereto. Referring to FIG. 2, the host device 10 comprises a USB host controller 32, a USB host driver stack 34, a plurality of software drivers 36 and a plurality of software applications 38. As noted above, the software drivers 36 and applications 38 are all stored in memory 35 in the host device, and more importantly, the host device 10 must contain a separate driver (and possibly a separate application) for each device that it may be coupled to during use. For example, if it was desired that the host device be compatible with 15 different types of devices, the host device would need to have the 15 corresponding drivers stored in its memory. In operation, once a peripheral device 20 is connected to the host, under command of the USB host controller 32, the USB host driver stack 34 searches all of the drivers 36 stored in the host memory and if there is a driver 36 that corresponds to the peripheral device 20, the driver is loaded by the host device 10, thereby allowing communication between the host device and the peripheral device. It is noted that the foregoing process corresponds to USB device enumeration, which is a well known process, and therefore is not further defined herein.

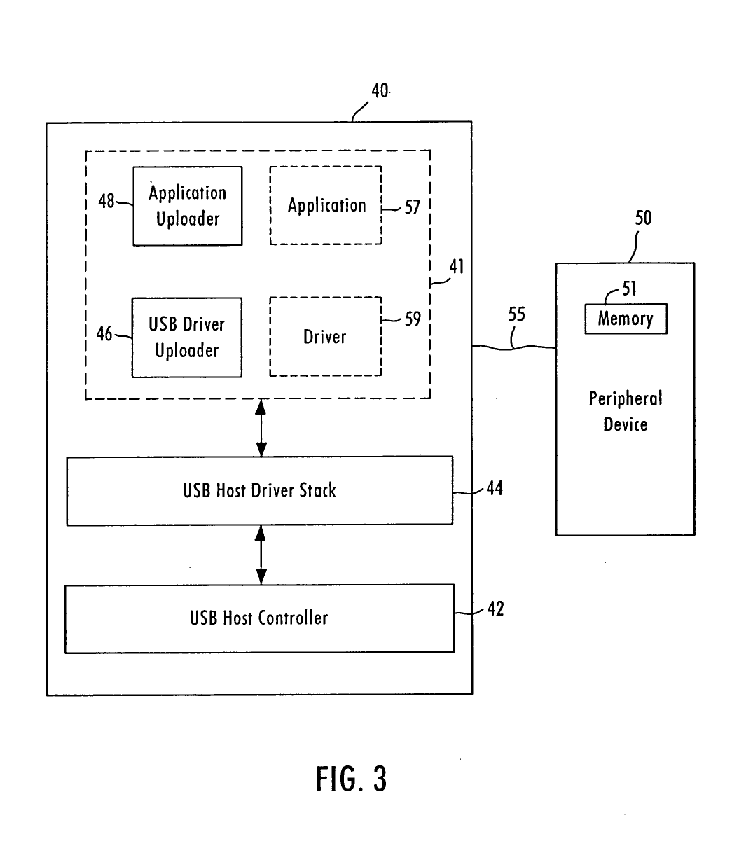

FIG. 3 is a block diagram illustrating in-part the contents of a host device 40 practicing the present invention. Referring to FIG. 3, the host device 40 comprises a USB host controller 42, a USB host driver stack 44, a USB driver uploader 46 and an application uploader 48. The USB host controller 42 and the USB host driver stack 44 are the same as the components illustrated in FIG. 2, and operate in substantially the same manner. The USB driver uploader 46 and the application uploader 48 are stored in the memory 41 of the host device 40.

As explained in more detail below, in accordance with the operation of the present invention, when a peripheral device 50 is connected to the host device 40, under command of the USB host controller 42, the USB host driver stack 44 loads the USB driver uploader program 46 from the host device memory 41. The host device 40 then executes the USB driver uploader 46, which results in the host device 46 uploading the driver necessary to communicate with the peripheral device 50 from the peripheral device itself. In other words, in accordance with the present invention, each peripheral device 50 has its corresponding driver stored in memory 51 within the peripheral device 50. Upon being coupled to a host device, the host device 40 functions to upload the driver from the peripheral device so as to allow for communication between the two devices.

Accordingly, the host device 40 no longer has to contain in its memory 41 a driver for every possible peripheral device that the host device may be coupled to. The host device need only contain the USB driver uploader 46 which provides the host device 40 the ability to retrieve the necessary driver from the peripheral device 50. It is noted that in accordance with the present invention, each of the peripheral devices must have its corresponding driver pre-installed in the memory 51 of the peripheral device 50. As a result of the present invention, it is no longer necessary for the manufacturer to predetermine what types and/or models of devices a host device (e.g., digital camera) can communicate with at the time of manufacture. The host device can communicate with any peripheral device having its driver pre-installed therein. Utilizing the foregoing example, practicing the present invention, the host device (i.e., digital camera) can be coupled to any type of peripheral device (e.g., printer), whereas in the prior art device, the digital camera could only be coupled to peripheral devices for which the corresponding drivers were pre-installed in the digital camera.

It is noted that each type of a given class of peripheral devices (e.g., printers) does not necessarily need its own driver. Some drivers (called “class drivers” in USB) are shared among similar products (for example, all printers can use a printer class driver). However, such class drivers have limitations because they only support common features (such as printing), and they do not support special features (such as double sided printing). In such instances, the driver of a particular peripheral device which utilizes such special features can be readily uploaded to the host device using the present invention.

It is noted that in accordance with the “USB-On-The-Go” specification, the host device is identified by utilizing the Host Negotiation Protocol. This protocol can also be utilized by the present invention in order to identify the host device. However, it is not intended that the present invention be limited to only this protocol. Clearly, there are other techniques for identifying/indicating a host device. Any such technique which allows for such identification can be utilized with the present invention. Currently, there are two techniques for determining which device is the host. The first being that the host controller has a A-receptacle (defined by the USB specification), and the second being the Host Negotiation Protocol mentioned above.

Referring again to FIG. 2, it is further noted that host device also includes an application uploader program 48. The application uploader 48 and the driver uploader 46 operate to upload the application and driver, respectively. It is noted that it is possible that the host device would not have to upload a new application for each peripheral device it is coupled to. For example, as noted above, assuming the host device contained an application for controlling a printer, it is possible that this application may be suitable for use with various printers. However, the present invention provides the host device with the ability to upload an application in the event the host needs the application to interact and/or control the given peripheral device. As with the drivers, the application specific to a given peripheral device would be stored in the memory 51 of the peripheral device 50.

Finally, FIG. 2 also illustrates an exemplary peripheral device 50 which is coupled to the host device 40 via a USB interface cable 55. As shown, the important aspect of the peripheral device as related to the present invention is that the peripheral device includes a memory 51 that contains the driver(s) and application(s) required for proper communication with, and operation of, the peripheral device, which can be accessed and uploaded by the host device 40.

The operation of the present invention is now described in more detail. When the host device 40 and the peripheral device 50 are first connected together, the role of the host and peripheral are determined in accordance with the “USB On-The-Go” specification. Then, the host will enumerate the peripheral device in accordance with the USB specification. Once this is performed, the USB core of the host device will determine the type of peripheral device and the driver necessary to communicate with the peripheral device. The identification of the peripheral device and the required driver is performed in accordance with the USB specification.

It is noted that the way a particular driver is selected/identified for a given peripheral device is by values described in peripheral device's Device, Interface, and Configuration Descriptors. If the peripheral device vendor ID and product ID (written in the Device Descriptor) matches with a driver, that driver is picked. If the class/subclass/protocol code matches with a class driver, that driver is picked and so forth. This matching framework is given by the USB specification, and the actual values in the descriptor are given by the specific class driver specification. The vendorID and productID values that are in the device descriptor can be taken from the USB Implementers Forum (USB IF). Similarly, the class/subclass/protocol code is written in class driver specification, and can be obtained from the USB IF.

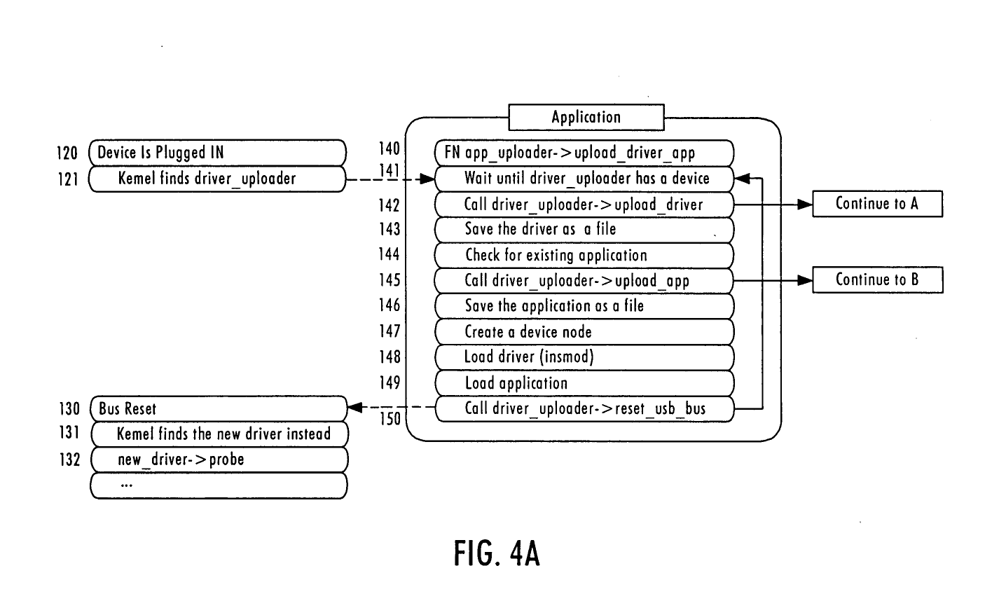

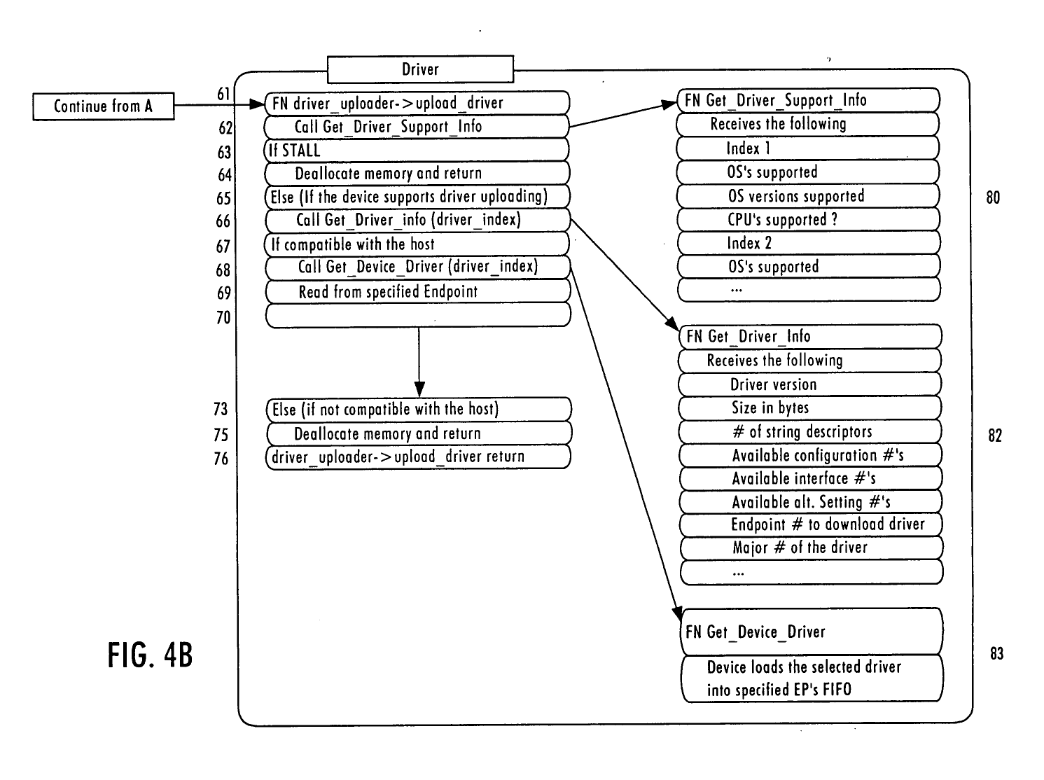

Once the driver is identified, in the current embodiment, the host device 40 will initially check its memory 41 to determine if the required driver has been pre-installed. If so, the USB host driver 44 will load the driver as the client driver. However, if the USB host driver 44 cannot find the required driver in its memory, the USB core will load the USB driver uploader 46 as the client driver, and then execute the driver uploader program. As discussed below, a flowchart illustrating the execution of an exemplary “USB driver uploader program” is set forth in FIG. 4B.

It is noted that when utilized in conjunction with a Linux operating system, the driver matching process should be performed by priority (e.g., if/else statements). It will choose the driver that matches its Vendor ID/Product ID first. Then it will match with the class drivers. The driver_uploader should be at the lowest priority (the last “else” clause), and it will only be loaded if none of the drivers were matched with the particular device connected to the host.

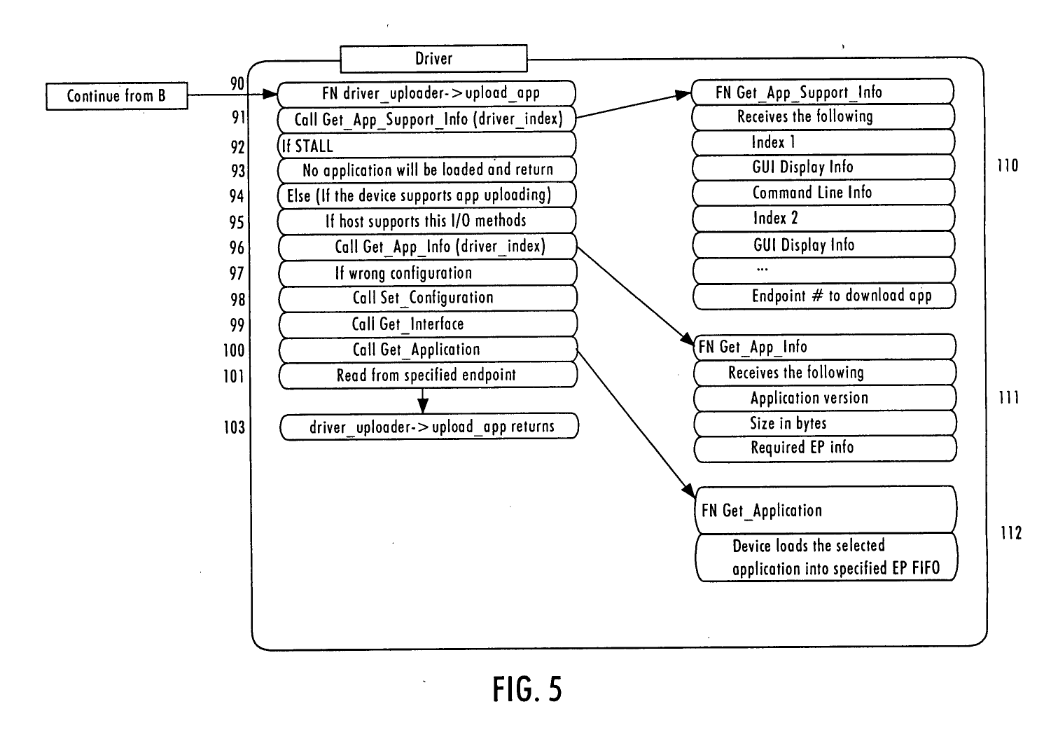

FIG. 4a is a flowchart illustrating an exemplary USB application uploader program in accordance with the present invention. It is noted that the exemplary flowcharts of FIGS. 4A, 4B, and 5 apply to a Linux operating systems. However, while the operation is illustrated in conjunction with a Linux system, the present invention is not intended to be so limited. The present invention can be utilized with any operating system capable of supporting module compilation and loading of drivers.

Referring to FIG. 4A, in Step 120, the peripheral device is coupled to the host device, and then the application uploader program waiting for a device to connect (Step 141) gets notified by the Driver Uploader that there is a device connected needing to upload a driver. It then calls driver uploader's “upload_driver” task (142). More specifically, the initial flow starts when the driver_uploader is loaded into memory. The app_uploader is loaded into the memory next and it calls upload_driver_app function (Step 140). In this function, the application waits for notification by the driver_uploader that a new device is attached and it is missing a driver (Step 120). The kernel first tries to match this device with registered drivers, but if it doesn't find any, it will match with the driver_uploader (Step 121) (which looks like a device driver to the Linux kernel). This is how the driver_uploader indicates to app_uploader that a device is waiting to find (and upload) a driver.

Continuing, in the event the host device does not have the required driver pre-installed in memory, the USB core of the host device will call the USB driver uploader 46 as the client driver (Step 142) and execute the program (Step 61 in FIG. 4B). Referring to FIG. 4B, in the first step, the USB core determines if the host device is capable of uploading the driver contained in the peripheral device. This is accomplished by performing the “Call Get_Driver_Support_Info” task (Step 62), which functions to retrieve, from the peripheral device, the information necessary to determine the requirements for executing the driver. As shown in Step 80 of FIG. 4A, the information retrieved from the peripheral device includes, but is not limited to, for example, the operating systems (OS) supported, the versions of the OS supported, and the CPU's supported. Once obtained, the host device determines from the received information whether or not the host device is capable of supporting the driver. If the host device determines it cannot support the peripheral's driver, the uploader program is terminated and memory allocated for receiving the peripheral's driver is deallocated (see, Steps 63 and 64).

However, if the host device determines that it can support the peripheral's driver, the program proceeds (Step 65) and performs the “Call_Get_Driver_Info” task (Step 66), which functions to obtain information regarding the driver from the peripheral device. For example, as shown in Step 82, the driver information includes, but is not limited to, an indication of the version of the driver, the size of the driver (e.g., number of bytes), the name of the driver (i.e., string descriptors), as well as the available configuration numbers, the available interface numbers, and the available setting numbers. If a Linux operating system is being utilized, the additional items may also be included: an endpoint number indicating where the driver will be transferred from and the major number, which is what Linux uses to connect application and driver. It is noted that the endpoint number is necessary regardless of the operating system. The endpoint number is used to indicate which FIFO in the peripheral device stores the driver as data. It is further noted that the configuration numbers, the interface numbers, and the setting numbers are defined in the USB specification, and therefore are not discussed in detail herein. Once this information is obtained, the host device determines whether or not the host device is capable of executing the driver. If the host device determines it cannot execute the peripheral's driver, the uploader program is terminated.

If the host device determines that it can execute the peripheral's driver, the program proceeds (Step 67) and performs the “Get_Device_Driver” task (Step 68), which functions to command the peripheral device to load the selected driver into accessible memory in the peripheral device so as to allow the host to retrieve the driver from the peripheral device. In the example set forth in the flowchart of FIG. 4B, the selected driver is loaded into a first-in, first-out (FIFO) memory at a specified endpoint location as shown in Step 83. Then in Step 69, the host device reads the driver from the specified endpoint location of the memory of the peripheral device. It is noted that while the given embodiment discloses the use of a FIFO, it is not limited thereto. The selected driver just needs to be prepared and made available for uploading.

Next, referring again to FIG. 4A, upon reading the driver from the peripheral device, in Step 143 the application uploader receives the driver as a file and stores the driver in memory until an application to be executed is found or uploaded.

As noted above, in certain instances it may also be necessary for the host device to retrieve an application from the peripheral device. If this is necessary, the application is uploaded from the peripheral device in substantially the same manner as the driver. In the current embodiment of the invention, the uploading of a given driver will trigger the uploading of all necessary applications associated with the given driver.

Accordingly, continuing with FIG. 4A, the next step in the process (Step 144) checks to determine if the host device already contains the necessary application prior to calling the application uploader. If the host device contains the application, the application is loaded and executed and the peripheral device can begin communicating with the host. However, if the host does not contain the necessary application, the process proceeds to Step 145 and the application uploader calls driver uploaders “upload app” and performs the program (Step 90).

Referring to FIG. 5, the “upload app” task entails performing the Call “Get_App_Support_Info” task (Step 91), which functions to retrieve, from the peripheral device, the information necessary to determine the requirements for executing the application. As shown in Step 110 of FIG. 5, the information retrieved from the peripheral device includes, but is not limited to, for example, the GUI information and the command line information. Once obtained, the host device determines from the received information whether or not the host device is capable of executing the application. If the host device determines it cannot support the peripheral's application, the uploader program is terminated (Steps 92 and 93).

However, if the host device determines that it can execute the application, including the I/O requirements, the program proceeds (Steps 94 and 95) and performs the “Call_Get_App_Info” task (Step 96), which functions to obtain information regarding the application from the peripheral device. For example, as shown in Step 111, the application information includes, but is not limited to, an indication of the version of the application, the size of the application (e.g., number of bytes), and the location of the application in the memory of the peripheral device (i.e., the endpoint “EP” information).

Once the application information is obtained by the host device, the host device determines if the configuration (e.g., available endpoint numbers and endpoint types (USB specific)) is acceptable for executing the program (Step 97) and if the configuration is wrong, the host device calls the “Set-Configuration” task (Step 98) and/or the “Set_Interface” task (Step 99) to reconfigure the device according to the specific application. These “calls” are defined by the USB specification, and the tasks are issued by the host to select sets of endpoint and types that are made available by the device.

Next, the Call “Get_Application” task (Step 100) is performed, which functions to command the peripheral device to load the selected application into accessible memory so as to allow the host device to retrieve the application. In the example set forth in the flowchart of FIG. 5, the selected application is loaded into a FIFO memory at a specified endpoint location as shown in Step 112. Then in Step 101, the host device reads the application from the specified endpoint of the memory of the peripheral device, and loads the application into the host device. The process then returns to the program illustrated in FIG. 4A (Step 103). Once again it is noted that the present invention is not limited to the use of a FIFO.

Referring again to FIG. 4A, once the application uploader receives the application, the application is saved in memory as a file (Step 146). Next, the program creates a device node (Step 147), loads the uploaded driver into memory (e.g., insmod command of Linux) (Step 148), and loads the uploaded application (Step 149). The program then issues a USB reset command to driver uploader (Step 150). The driver uploader passes the command down the stack and eventually, the particular device receives the USB reset signal (Step 130). The USB driver stack then re-enumerates the peripheral device (Steps 131, 132). At this time, the newly installed driver is found by the O/S and matched with the driver, and the device is connected to the new driver and new application, and capable of communication.

Thus, in accordance with the present invention, it is possible to upload from a given peripheral device to a host device both the driver and application necessary for providing functional interaction and communication between the peripheral device and the host device.

Of course, the foregoing examples of retrieving either the driver or the application from the peripheral device illustrated in the flowcharts of FIGS. 4A, 4B and 5 are intended to illustrative, and not limiting in any manner whatsoever. Indeed, as would be apparent to someone skilled in the art, it is possible to upload either the driver or application in other manners.

Additional variations are also possible. For example, it is possible to store an application, which is generic to numerous models of the given peripheral (e.g., a printer application), in the host so that the host does not have to upload the application each time it is connected to another printer. In this example, the printer application could be utilized with numerous different types of printers.

It addition, it may be possible to load some drivers in the host device during the manufacturing process. For example, if the manufacturer knows in advance that the host device is likely to be coupled to a given peripheral device(s), the manufacturer can install the driver for the given peripheral in the host memory so that the host device will not have to upload the driver if used with the given peripheral. However, the host device would still possess the capabilities of uploading the necessary drivers and applications when coupled to peripheral devices other than the given peripheral. Such a driver is indicated by element 59 in FIG. 3.

It is noted that the exemplary flowcharts illustrated herein show the steps of uploading drivers and applications and installation thereof utilizing a Linux operating system. However, the present invention is not intended to be limited to implementation over a Linux operating system. It is clearly possible to performing the uploading of applications and drivers in accordance with the present invention utilizing other operating systems.

As described above, the present invention provides significant advantages over the prior art. Most importantly, the present invention basically unconditionally expands the number of peripheral devices that a given host device can be connected to. In other words, manufacturers are no longer limited to specifying a set number of peripheral devices that a given host can be coupled to (which in the prior art is limited by the number of drivers that can be stored in the host device at the time of manufacture). In accordance with the present invention, if the host device does not contain the necessary driver and application to interact with a peripheral device, the driver and application are simply uploaded from the peripheral device.

Another advantage is that the present invention reduces the amount of memory necessary for the host device. More specifically, as the host device is no longer required to store all of the drivers and applications for which the manufacturer wishes the host to be compatible with, the memory requirements of the host device are significantly reduced.

Although certain specific embodiments of the present invention have been disclosed, it is noted that the present invention may be embodied in other forms without departing from the spirit or essential characteristics thereof. The present embodiments are therefor to be considered in all respects as illustrative and not restrictive, the scope of the invention being indicated by the appended claims, and all changes that come within the meaning and range of equivalency of the claims are therefore intended to be embraced therein.

1. A method of installing a software program in a host device, said software program being required for said host device to communicate with a peripheral device, said method comprising the steps of:
coupling said host device to said peripheral device utilizing a USB serial interface, said peripheral device containing said software program stored in a memory device contained in said peripheral device;
uploading said software program from said peripheral device to said host device over said USB serial interface; and
installing said software program in said host device thereby allowing communication between said host device and said peripheral device.

2. The method of installing a software program in a host device according to claim 1, wherein said software program is a driver associated with said peripheral device which allows for communication between said host device and said peripheral device.

3. The method of installing a software program in a host device according to claim 1, wherein said software program is an application for executing a functional operation associated with the operation of the peripheral device.

4. The method of installing a software program in a host device according to claim 1, wherein host device and said peripheral device communicate with one another utilizing the USB specification.

5. A method of installing a software program in a host device, said software program being required for said host device to communicate with a peripheral device, said method comprising the steps of:
coupling said host device to said peripheral device utilizing a USB serial interface, said peripheral device containing said software program stored in a memory device contained in said peripheral device; and
determining if said host device comprises a copy of said software program stored in a memory device contained in said host device;
wherein if said host device comprises said software program in said memory device contained in said host device, said host device installs said software program so as to allow communication between said host device and said peripheral device, and if said host device does not comprise said software program in said memory device contained in said host device, said host device uploads said software program from said peripheral device to said host device over said USB serial interface, and installs said software program in said host device thereby allowing communication between said host device and said peripheral device.

6. The method of installing a software program in a host device according to claim 5, wherein said software program is a driver associated with said peripheral device, which allows for communication between said host device and said peripheral device.

7. The method of installing a software program in a host device according to claim 5, wherein said software program is an application for executing a functional operation associated with the operation of the peripheral device.

8. The method of installing a software program in a host device according to claim 5, wherein host device and said peripheral device communicate with one another utilizing the USB specification.

9. A host device capable of communicating with any one of a plurality of peripheral devices utilizing a USB serial interface, each of said plurality of peripheral devices having the software driver necessary for communicating with a given peripheral stored in a memory device contained in said given peripheral, said host device comprising:
a USB interface capable of defining said host device as a master device relative to said plurality of peripheral devices,
a software driver uploader for uploading the software driver of a given one of said plurality of peripheral devices, which is coupled to said host device via said USB serial interface, and
a software driver installer for installing said software driver uploaded from said given one of said plurality of peripheral devices so as to allow communication between said host device and said given one of said plurality of peripheral devices.

10. The method of installing a software program in a host device according to claim 9, wherein host device and said given one of said plurality of peripheral devices communicate with one another utilizing the USB specification.
